(19) United States
(12) Patent Application Publication
(10) Pub. No.: US 2025/0178856 A1
(43) Pub. Date: Jun. 5, 2025

(54) RACK MOUNTED INSPECTION AND CLEANING TOOL

(71) Applicant: INTERNATIONAL BUSINESS MACHINES CORPORATION, ARMONK, NY (US)

(72) Inventors: FAEZEH GHOLAMI, RIDGEWOOD, NJ (US); RAFAELA FROTA, POUGHKEEPSIE, NY (US); JOHN S. WERNER, FISHKILL, NY (US); ANDREW C. M. HICKS, HIGHLAND, NY (US)

(21) Appl. No.: 18/526,409

(22) Filed: Dec. 1, 2023

(51) Int. Cl. B65H 49/32

(52) U.S. Cl. CPC B65H 49/32; B65H 2301/5115; B65H 2553/42; B65H 2701/32

(57) ABSTRACT

Methods, apparatus, and systems for inspecting and cleaning optical interconnects include inspecting, by a light scattering detection system and an imaging processing system of an inspection and cleaning tool, a surface of an optical cable interconnect; determining, based on measurements from the light scattering detection system and the imaging processing system, whether the surface of the optical cable interconnect is clean; and cleaning, based on determining that the surface of the optical cable interconnect is not clean, the surface of the optical cable interconnect.

### BACKGROUND

### Field of the Disclosure

The field of the disclosure is computer maintenance, or, more specifically, methods and systems for inspecting and cleaning optical interconnects.

### Description of Related Art

Optical cables are used to transmit information across distances and are commonly used in computing environments. When the endpoint surfaces of an optical cable and its associated optical cable interconnect within a computing component get dirty, the performance of the cable can suffer. For rack computers that utilize many different optical cables and have many optical cable interconnects, maintaining and cleaning those cables and interconnects can be time and labor intensive.

### SUMMARY

Methods and systems for inspecting and cleaning optical interconnects according to various embodiments are disclosed in this specification. In accordance with one aspect of the present disclosure, a method of inspecting and cleaning optical interconnects may include inspecting, by a light scattering detection system and an imaging processing system of an inspection and cleaning tool, a surface of an optical cable interconnect; determining, based on measurements from the light scattering detection system and the imaging processing system, whether the surface of the optical cable interconnect is clean; and cleaning, based on determining that the surface of the optical cable interconnect is not clean, the surface of the optical cable interconnect.

In accordance with another aspect of the present disclosure, inspecting and cleaning optical interconnects may include a system including a rack including one or more systems, where at least one of the one or more systems includes an optical cable and an associated optical cable interconnect; an inspection and cleaning system comprising: an inspection and cleaning tool; and a rack mechanism coupling the inspection and cleaning tool to the rack, where the rack mechanism is configured to automatically position the inspection and cleaning tool to align with an optical cable interconnect; where the inspection and cleaning tool includes: a light scattering detection system; an imaging processing system, where the light scattering detection system and the imaging processing system are used to determine whether a surface of the optical cable interconnect is clean; and a cleaning system configured to clean the optical cable interconnect based on a determination that the surface of the optical cable interconnect is not clean.

The foregoing and other objects, features and advantages of the disclosure will be apparent from the following more particular descriptions of exemplary embodiments of the disclosure as illustrated in the accompanying drawings wherein like reference numbers generally represent like parts of exemplary embodiments of the disclosure.

### BRIEF DESCRIPTION OF THE DRAWINGS

FIG. 1 shows a block diagram of an example rack and an attached system configured for inspecting and cleaning optical interconnects in accordance with embodiments of the present disclosure.

FIG. 2 shows a block diagram of an example inspection and cleaning tool configured for inspecting and cleaning optical interconnects in accordance with embodiments of the present disclosure.

FIG. 3 is a block diagram of an example computing environment configured for inspecting and cleaning optical interconnects according to some embodiments of the present disclosure.

FIG. 4 is a flowchart of an example method for inspecting and cleaning optical interconnects according to some embodiments of the present disclosure.

FIG. 5 is a flowchart of another example method for inspecting and cleaning optical interconnects according to some embodiments of the present disclosure.

FIG. 6 is a flowchart of another example method for inspecting and cleaning optical interconnects according to some embodiments of the present disclosure.

### DETAILED DESCRIPTION

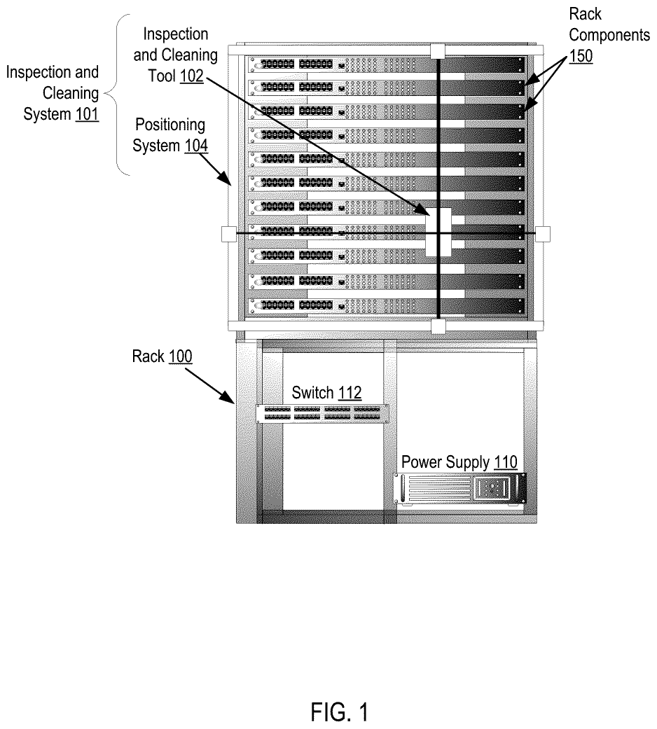

Exemplary methods, apparatus, and systems for inspecting and cleaning optical interconnects in accordance with the present disclosure are described with reference to the accompanying drawings, beginning with FIG. 1. FIG. 1 sets forth a block diagram of an example system configured for inspecting and cleaning optical interconnects in accordance with embodiments of the present disclosure. The example system of FIG. 1 includes a rack 100 and an inspection and cleaning system 101 mounted onto the rack 100.

The example rack 100 of FIG. 1 is configured to hold computing components, such as a power supply 110, a switch 112, and other rack components 150. Rack components may include any computing components configured to mount to a computer rack. In the embodiment of FIG. 1, one or more of the rack components 150 are coupled to optical cables (such as fiber optical cables), where the optical cable is configured to mount to the rack component via an optical cable interconnect included on the rack component.

The example inspection and cleaning system 101 of FIG. 1 is configured to automatically inspect and clean optical cables or optical cable interconnects included within the rack 100. The inspection and cleaning system 101 includes an inspection and cleaning tool 102 and a positioning system 104 coupled to the inspection and cleaning tool 102. The positioning system 104 is a rack mechanism that is configured to automatically reposition the inspection and cleaning tool 102 to align it with various optical cables or optical cable interconnects within the rack 100 for inspecting and cleaning. The positioning system 104 may include motors, drive belts, tracks, and other positioning components. The positioning system 104 may rely on visual recognition software or an x-y positioning file when aligning the inspection and cleaning tool 102 with an interconnect. In another embodiment, the FIG. 1 shows the positioning system 104 configured to move the inspection and cleaning tool 102 along the x-axis (across the width of the rack) and along the z-axis (across the height of the rack). However, not shown in FIG. 1, the positioning system 104 is also configured to move the inspection and cleaning tool 102 along the y-axis (across the depth of the rack 100), towards or away from the rack components 150. By moving the inspection and cleaning tool 102 towards or away from the rack components 150, the inspection and cleaning tool 102 may be configured to unplug optical cables from the rack components (such as prior to inspection and cleaning) or plug the cables back into their respective optical cable interconnects in the rack components (such as after inspection and cleaning).

The inspection and cleaning tool 102 may be configured to communicate with one or more components of the rack either directly or through the switch 112 and via a wireless or wired connection. In one embodiment, the inspection and cleaning tool 102 is configured to receive instructions from a computing system (either within the rack 100 or outside of the rack) to inspect or clean one or more specific optical cables or optical cable interconnects within the rack. The inspection and cleaning tool 102 is also configured to communicate with one or more computing systems inside the rack (or outside the rack), such as providing inspection or cleaning results based on the obtained measurements or conducted activities associated with the inspection and cleaning tool 102. Such results may include which components or interconnects were cleaned, needed cleaning, passed inspections, and the like. The inspection and cleaning system 101 may be powered via an internal power supply, a power supply included in the rack (such as power supply 110), or by any other power supply. The inspection and cleaning system 101 of FIG. 1 is depicted as being mounted to the front side of the rack 100. In an alternative embodiment, the inspection and cleaning system 101 may be mounted to any other side (such as the back side) of the rack 100.

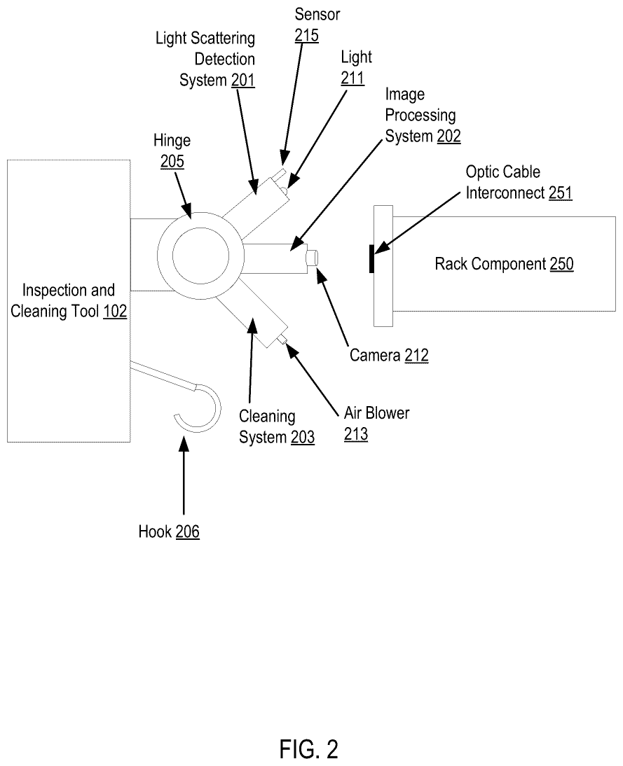

For further explanation, FIG. 2 sets forth a block diagram of an example inspection and cleaning tool configured for inspecting and cleaning optical interconnects in accordance with embodiments of the present disclosure. Specifically, FIG. 2 shows the inspection and cleaning tool 102 interacting with a rack component 250 of the rack 100 of FIG. 1. The rack component 250 of FIG. 2 includes an optical cable interconnect 251 configured to couple to an optical cable. The rack component 250 may include multiple other optical cable interconnects (not shown in FIG. 2).

The example inspection and cleaning tool 102 of FIG. 2 is configured to inspect and clean the optical cable interconnect 251 of the rack component 250. The inspection and cleaning tool 102 of FIG. 2 includes three systems; namely, a light scattering detection system 201, an image processing system 202, and a cleaning system 203. In the embodiment of FIG. 2, the inspection and cleaning tool 102 also includes a hinge 205 configured to select which of the three systems (201, 202, or 203) is aligned with the optical cable interconnect 251. The hinge 205 may be controlled by the inspection and cleaning tool 102 via software, which may be included within the tool itself. For example, when inspecting the optical cable interconnect 251, the inspection and cleaning tool 102 may first inspect the interconnect with the image processing system 202 and then operate the hinge to align the light scattering detection system 201 with the interconnect for further inspection. In another example, the inspection and cleaning tool 102 may, after inspecting the interconnect, operate the hinge 205 to align the cleaning system 203 with the interconnect to clean the interconnect. In an alternative embodiment, the inspection and cleaning tool 102 may include any other mechanism instead of a hinge that is configured to align the systems with the optical cable interconnect. For example, the tool could be configured so that the positioning system 104 is used to select which system is aligned with the interconnect. In another embodiment, the inspection and cleaning tool 102 may be configured such that all three systems may be simultaneously aligned with the interconnect, such that repositioning of the tool is not required between the inspecting and cleaning steps.

The example light scattering detection system 201 of FIG. 2 is configured to inspect the surface of an optical cable or an optical cable interconnect (such as optical cable interconnect 251). When inspecting the interconnect, the light scattering detection system 201 may be used alone for the inspection or in combination with the image processing system 202. The light scattering detection system 201 of FIG. 2 includes a light 211 and a sensor 215. The light scattering detection system 201 is configured to shine (from light 211) onto the surface of the interconnect and then use the sensor 215 to measure the light reflected off of the surface of the interconnect. By analyzing the reflected light off the surface of the interconnect, the light scattering detection system 201 is configured to determine the presence of particles on the surface of the optical cable interconnect. The light scattering detection system 201 includes software (which may be included within the inspection and cleaning tool 102) for analyzing the measurements from the sensor and determining whether the surface of the optical cable interconnect is clean.

The example image processing system 202 is configured to inspect the surface of an optical cable or an optical cable interconnect (such as optical cable interconnect 251). When inspecting the interconnect, the image processing system 202 may be used alone for the inspection or in combination with the light scattering detection system 201. The image processing system 202 includes a camera 212 configured to create images of the surface of the interconnect for inspection. The image processing system 202 also includes software (which may be included within the inspection and cleaning tool 102) for analyzing the image obtained from the camera 212 and determining whether the surface of the optical cable interconnect is clean. Specifically, the image processing system 202 is configured to analyze an image of the surface of the interconnect and determine whether there are any particles or other substances present on the surface. The inspecting of the surface by the image processing system 202 may be carried out prior to, after, or during the inspecting of the surface by the light scattering detection system 201.

When inspecting a surface for cleanliness, whether by the light scattering detection system 201 or the image processing system 202, the inspection and cleaning tool 102 is configured to compare the measurements obtained from such systems with previously known baseline measurements. Such baseline measurements are associated with a known clean surface of an optical cable interconnect (or optical cable). By comparing incoming measurements with a known baseline, the inspection and cleaning tool 102 can determine whether the surface of the optical cable interconnect is sufficiently clean or if the surface requires cleaning by the inspection and cleaning tool 102. For example, the inspection and cleaning tool 102 may determine if the surface is clean based on a determination of whether the measurements differ from the baseline by a threshold amount. In such an example, if the inspection and cleaning tool 102 determines that the measurements obtained (from either the light scattering detection system 201 or the image processing system 202) differ from the baseline by an amount greater than a predetermined threshold, then the inspection and cleaning tool 102 will determine that the surface of the optical cable interconnect 251 is not clean.

The example cleaning system 203 is configured to clean the surface of an optical cable or an optical cable interconnect (such as optical cable interconnect 251). The cleaning system 203 of FIG. 2 includes an air blower 213 configured to apply one or more bursts of air onto the surface being cleaned to remove particles or other substances from the surface. In another embodiment, not shown in FIG. 2, the cleaning system 203 may include other cleaning components, such as a wipe, solvents, brush, and the like. The cleaning system 203 is configured to clean the surface of an interconnect or cable only after the inspection and cleaning tool 102 has determined that the surface is not sufficiently clean. In another embodiment, the inspection and cleaning tool 102 may clean the surface in response to receiving instructions from another computing system instructing the tool to clean the surface. In such an embodiment, the inspection and cleaning tool 102 may clean the surface without first inspecting the surface.

The inspection and cleaning tool 102 of FIG. 2 also includes a hook 206 configured to reposition cables associated with the optical cable interconnect or the rack component 250 (or other components in the rack). For example, the hook may be configured to hold one or more cables out of the way when inspecting and cleaning a surface. In another embodiment, the hook may be configured to unplug a cable from the optical cable interconnect 251 prior to inspecting and cleaning the surface of the optical cable interconnect 251, and then subsequently plugging the cable (via the hook 206) back into the optical cable interconnect 251. Such plugging and unplugging may be carried out automatically (via software) as part of the inspecting and cleaning process. In an alternative embodiment, the inspection and cleaning tool 102 may use any other mechanism besides a hook for manipulating cables or cable connectors when performing the inspecting and cleaning operations.

In the example of FIG. 1 and FIG. 2, the inspection and cleaning tool 102 is shown as being mounted to the rack 100. In an alternative embodiment, the inspection and cleaning tool 102 may be a handheld device configured to be operated by a user holding the inspection and cleaning tool 102.

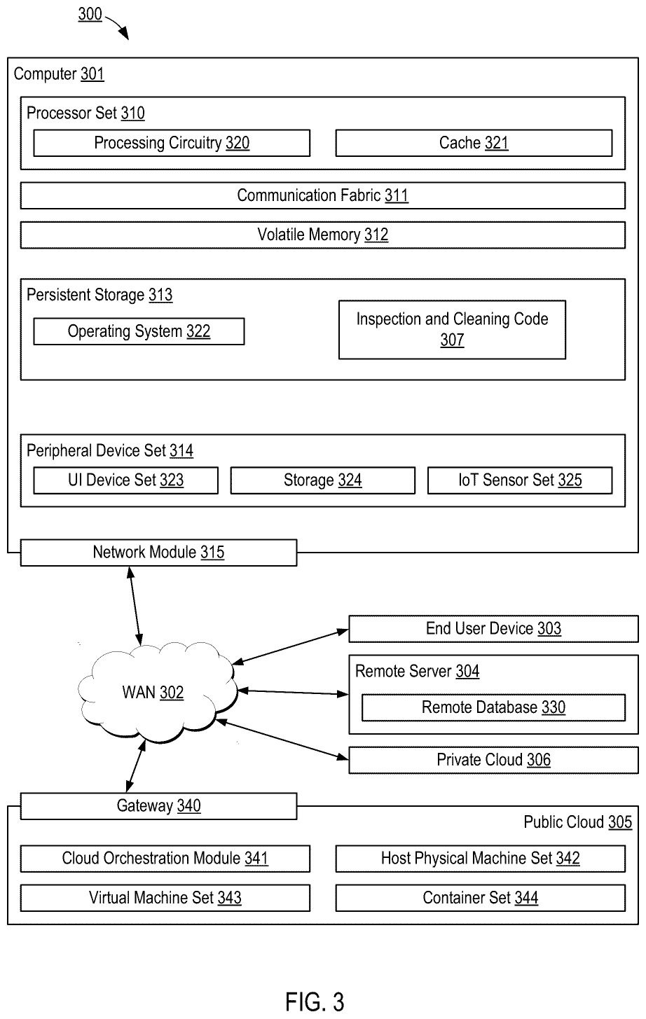

For further explanation, FIG. 3 sets forth a block diagram of computing environment 300 configured for inspecting and cleaning optical interconnects in accordance with embodiments of the present disclosure. Computing environment 300 contains an example of an environment for the execution of at least some of the computer code involved in performing the inventive methods, such as inspection and cleaning code 307. In addition to inspecting and cleaning code 307, computing environment 300 includes, for example, computer 301, wide area network (WAN) 302, end user device (EUD) 303, remote server 304, public cloud 305, and private cloud 306. In this example embodiment, computer 301 may be part of, or included within, the inspection and cleaning system 101 of FIG. 1, and includes processor set 310 (including processing circuitry 320 and cache 321), communication fabric 311, volatile memory 312, persistent storage 313 (including operating system 322 and inspecting and cleaning code 307, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

Computer 301 may take the form of a desktop computer, laptop computer, tablet computer, smart phone, wearable computer, smart watch, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

Processor set 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in inspecting and cleaning code 307 in persistent storage 313.

Communication fabric 311 is the signal conduction path that allows the various components of computer 301 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

Persistent storage 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in inspecting and cleaning code 307 typically includes at least some of the computer code involved in performing the inventive methods.

Peripheral device set 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

Network module 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 303 is any computer system that is used and controlled by an end user (for example, a customer of an enterprise that operates computer 301), and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

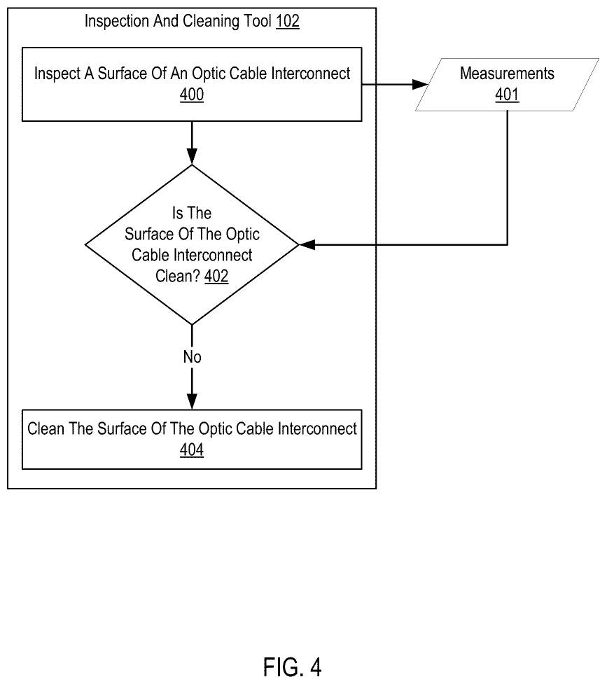

For further explanation, FIG. 4 sets forth a flow chart illustrating an exemplary method of inspecting and cleaning optical interconnects according to embodiments of the present disclosure. The method of FIG. 4 includes inspecting 400 a surface of an optical cable interconnect. Inspecting 400 a surface of an optical cable interconnect may be carried out by the inspection and cleaning tool 102 obtaining measurements 401 associated with the surface of the optical cable interconnect. The measurements 401 may be obtained from the light scattering detection system 201 or the image processing system 202 (or both) and may include information describing various particles or substances present on the surface of the interconnect. For example, the measurements may include a percentage of the surface that is clear of particles or substances.

The method of FIG. 4 also includes determining 402 whether the surface of the optical cable interconnect is clean. Determining 402 whether the surface of the optical cable interconnect is clean may be carried out by the inspection and cleaning tool 102 comparing the measurements 401 associated with the surface of the optical cable interconnect with a threshold or a baseline. For example, in one embodiment, the inspection and cleaning tool 102 may compare the percentage of the surface that is clear of particles or substances with a predetermined threshold percentage that is determined as being ‘clean’ for purposes of normal operation by the rack component. In another example, the measurements may be compared with a baseline measurement representing a known clean surface. In such a comparison, the inspection and cleaning tool 102 may determine that the surface is not clean based on the measurements differing from the baseline measurements by an amount exceeding a threshold.

The method of FIG. 4 also includes cleaning 404 the surface of the optical cable interconnect. Cleaning 404 the surface of the optical cable interconnect may be carried out by the inspection and cleaning tool 102 using a cleaning system (such as the cleaning system 203 of FIG. 2) to remove particles or other substances from the surface of the optical cable interconnect. Cleaning 404 the surface of the optical cable interconnect is carried out in response to determining that the surface is not clean. For example, the inspection and cleaning tool 102 is configured to clean only the surfaces that require cleaning based on a prior inspection. By cleaning only the interconnects that need to be cleaned, the inspection and cleaning tool 102 streamlines the process of making sure that every optical cable or optical cable interconnect within the rack is clean (a process that would take considerable time if done manually).

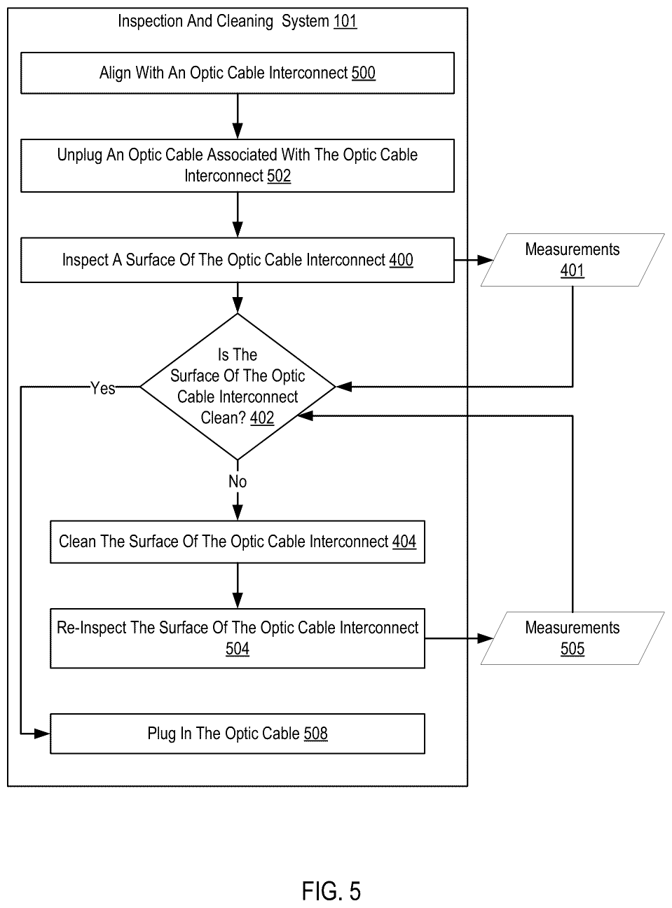

For further explanation, FIG. 5 sets forth a flow chart illustrating another exemplary method of inspecting and cleaning optical interconnects according to embodiments of the present disclosure. The method of FIG. 5 differs from the method of FIG. 4 in that the method of FIG. 5 further includes aligning 500 with an optical cable interconnect. Aligning 500 with an optical cable interconnect may be carried out by the inspection and cleaning system 101 using the positioning system to align the inspection and cleaning tool 102 with the optical cable interconnect.

The method of FIG. 5 further includes unplugging 502 an optical cable associated with the optical cable interconnect. Unplugging 502 an optical cable associated with the optical cable interconnect may be carried out by the inspection and cleaning system 101 using the inspection and cleaning tool 102 to grab the optical cable currently plugged into the optical cable interconnect and then using the positioning system 104 to pull the cable out from the optical cable interconnect of the rack component. In one embodiment, the inspection and cleaning tool 102 is configured to hold onto the unplugged cable during the inspection and cleaning process and then plug the cable back in after it is determined that the surface of the interconnect is clean. In one embodiment, only the interconnects having cables are cleaned within the rack. In another embodiment, interconnects which are not being used or have a cable plugged into them may be inspected and cleaned.

Unplugging 502 the optical cable may include identifying, by the inspection and cleaning tool 102, a type of cable or cable connector associated with the optical cable. For example, the inspection and cleaning tool 102 may identify which method is required for removing the cable from the interconnect. In another embodiment, the inspection and cleaning tool 102 may be configured to adapt to multiple different cable types when automatically unplugging optical cables from the optical cable interconnect.

The method of FIG. 5 further includes, after cleaning 404 the surface of the optical cable interconnect, re-inspecting 504 the surface of the optical cable interconnect. Re-inspecting 504 the surface of the optical cable interconnect may be carried out by the inspection and cleaning system 101 using the inspection and cleaning tool 102 to inspect the optical cable interconnect after it has been cleaned. In one embodiment, every surface that is cleaned by the inspection and cleaning tool 102 is subsequently re-inspected to determine 402 whether the surface has been sufficiently cleaned. If it is determined 402, based on the measurements 505 obtained during the re-inspection, that the surface of the optical cable interconnect is still not clean, the inspection and cleaning tool 102 is configured to repeat the cleaning 404, re-inspecting 504, and determining 402 steps until the surface is clean. The re-inspecting 504 of the surface may be carried out in the same way as the inspecting 400 step of FIG. 4.

The method of FIG. 5 further includes plugging 508 in the optical cable. Plugging 508 in the optical cable may be carried out by the inspection and cleaning system 101 first using the inspection and cleaning tool 102 to hold the optical cable that was previously unplugged and then using the positioning system 104 to plug the cable back in to the optical cable interconnect of the rack component. Plugging 508 in the optical cable may be carried out only in response to determining that the surface of the interconnect is clean. The embodiments of FIG. 5 describe inspecting and cleaning an optical cable interconnect. However, in an alternative embodiment, the method of FIG. 5 may be carried out for inspecting and cleaning an optical cable (such as a cable unplugged from an interconnect). In some embodiments, the method of FIG. 5 may be carried out for inspecting and cleaning both the interconnect and the cable plugged into the interconnect, so that both are determined to be clean before plugging the cable back into the interconnect.

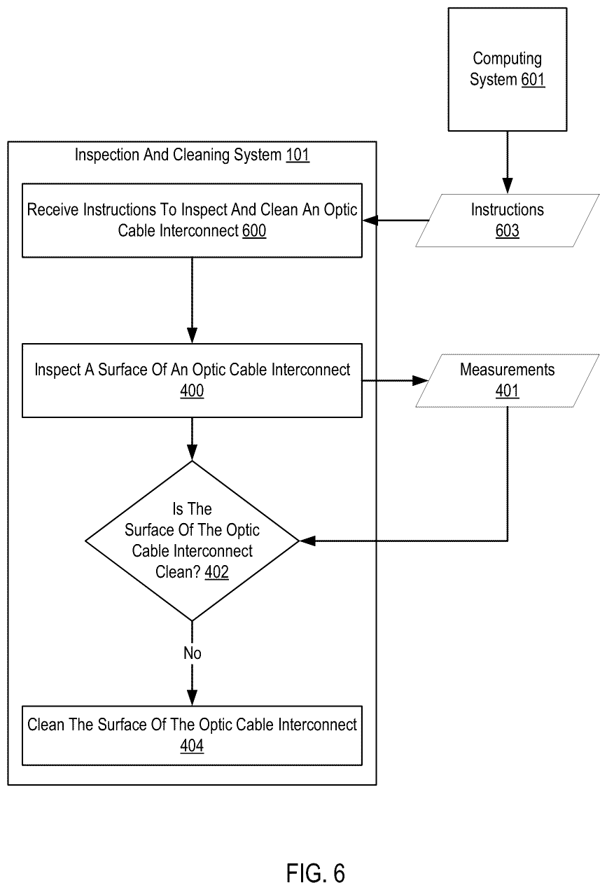

For further explanation, FIG. 6 sets forth a flow chart illustrating another exemplary method of inspecting and cleaning optical interconnects according to embodiments of the present disclosure. The method of FIG. 6 differs from the method of FIG. 4 in that the method of FIG. 6 includes receiving 600 instructions to inspect and clean an optical cable interconnect. Receiving 600 instructions to inspect and clean an optical cable interconnect may be carried out by the inspection and cleaning system 101 getting instructions 603 from a computing system 601. The instructions 603 may be received over a network (such as a wireless network) or through a wired connection with the computing system 601. The computing system 601 may be any computing system included within the rack 100 or may be a computing system remote from the rack 100.

The example instructions 603 of FIG. 6 may specify the rack component within the rack and may further specify the specific one or more optical cables or optical cable interconnects to be inspected and cleaned. The instructions 603 may specify which operations the inspection and cleaning tool should carry out, such as inspect, clean, or both. For example, the instructions 603 may specify to only inspect a surface of an optical cable interconnect and then report on the inspection results. In another example, the instructions 603 may specify to inspect a surface and then clean the surface if needed.

The instructions 603 to inspect and clean an optical cable interconnect may be sent to the inspection and cleaning system 101 based on one or more triggers. For example, the instruction may be sent based on error rate associated with the particular optical cable interconnect exceeding a threshold. In another embodiment, the instruction may be sent based on error rate associated with the rack component exceeding a threshold (with the instruction indicating to inspect and clean multiple or all of the optical cable interconnect in the rack component). In another embodiment, the instruction may be sent based on performance degrading or a time period passing since the last time the rack component's interconnects were cleaned.

In view of the explanations set forth above, readers will recognize that the benefits of inspecting and cleaning optical interconnects according to embodiments of the present disclosure include:
Increasing system efficiency by keeping optical cables and interconnects clean, thereby helping to prevent errors.
Decreasing inspection and cleaning time by automatically performing the tasks.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. An apparatus for inspecting and cleaning optical interconnects, comprising:
a rack mechanism; and
an inspection and cleaning tool, wherein:
the rack mechanism is configured to couple the inspection and cleaning tool to a rack, and position the inspection and cleaning tool to align with an optical cable interconnect; and
the inspection and cleaning tool includes a light scattering detection system, an image processing system, and a cleaning system, wherein the light scattering detection system and the image processing system are used to determine whether a surface of the optical cable interconnect is clean and the cleaning system is configured to clean the optical cable interconnect based on a determination that the surface of the optical cable interconnect is not clean.

2. The apparatus of claim 1, further comprising a hook configured to control a position of an optical cable associated with the optical cable interconnect.

3. The apparatus of claim 1, wherein the image processing system includes a camera.

4. The apparatus of claim 1, wherein the light scattering detection system includes a light and a sensor.

5. The apparatus of claim 1, wherein the cleaning system includes an air blower.

6. The apparatus of claim 5, wherein cleaning the optical cable interconnect includes blowing air on the optical cable interconnect via the air blower of the cleaning system.

7. The apparatus of claim 1, wherein the rack mechanism is configured to reposition the inspection and cleaning tool to align with a second optical cable interconnect.

8. The apparatus of claim 1, wherein the determination that the optical cable interconnect is not clean is based on determining that measurements from the light scattering detection system and the image processing system differ from a known baseline by a threshold amount.

9. A method for inspecting and cleaning optical interconnects, the method comprising:
inspecting, by a light scattering detection system and an image processing system of an inspection and cleaning tool, a surface of an optical cable interconnect;
determining, based on measurements from the light scattering detection system and the image processing system, whether the surface of the optical cable interconnect is clean; and
cleaning, based on determining that the surface of the optical cable interconnect is not clean, the surface of the optical cable interconnect.

10. The method of claim 9, where inspecting the surface of the optical cable interconnect includes:
measuring, via a sensor included in the light scattering detection system, light reflected off the surface of the optical cable interconnect; and
analyzing, by the image processing system, an image of the surface of the optical cable interconnect.

11. The method of claim 9, wherein determining that the surface of the optical cable interconnect is not clean includes determining that the measurements from the light scattering detection system and the image processing system differ from a known baseline by a threshold amount.

12. The method of claim 9, wherein cleaning the surface of the optical cable interconnect includes blowing air on the surface of the optical cable interconnect.

13. The method of claim 9, further comprising re-inspecting the surface of the optical cable interconnect after the cleaning, including determining whether the surface has been cleaned according to a threshold.

14. The method of claim 13, wherein the inspection and cleaning tool is configured to repeat the cleaning and the re-inspecting until the surface of the optical cable interconnect is determined to have been cleaned according to the threshold.

15. The method of claim 9, further comprising:
aligning the inspection and cleaning tool with the optical cable interconnect;
unplugging an optical cable associated with the optical cable interconnect; and
plugging, after performing the cleaning, in the optical cable back in its original position.

16. A system for inspecting and cleaning optical interconnects, the system comprising:
a rack including one or more systems, wherein at least one of the one or more systems includes an optical cable and an associated optical cable interconnect; and
an inspection and cleaning system comprising:
a rack mechanism and an inspection and cleaning tool, wherein the rack mechanism is configured to couple the inspection and cleaning tool to the rack, and position the inspection and cleaning tool to align with the optical cable interconnect; and
the inspection and cleaning tool includes a light scattering detection system, an image processing system, and a cleaning system, wherein the light scattering detection system and the image processing system are used to determine whether a surface of the optical cable interconnect is clean and the cleaning system is configured to clean the optical cable interconnect based on a determination that the surface of the optical cable interconnect is not clean.

17. The system of claim 16, wherein the inspection and cleaning system is mounted to a back side of the rack.

18. The system of claim 16, wherein the rack mechanism controls the position of the inspection and cleaning tool based on visual recognition software.

19. The system of claim 16, wherein the rack mechanism is configured to reposition the inspection and cleaning tool to align with a second optical cable interconnect.

20. The system of claim 16, wherein the determination that the surface of the optical cable interconnect is not clean is based on determining that measurements from the light scattering detection system and the image processing system differ from a known baseline by a threshold amount.
